(19) United States
(12) Patent Application Publication
(10) Pub. No.: US 2010/0241668 A1
(43) Pub. Date: Sep. 23, 2010

(54) Local Computer Account Management at Domain Level

(75) Inventors: Ferry Susanto, Bellevue, WA (US); Jianhui Xie, Redmond, WA (US); Michael K. Liptack, Monroe, WA (US); Steven F. Goddard, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/406,026

(22) Filed: Mar. 17, 2009

(51) Int. Cl. G06F 17/30

(52) U.S. Cl. 707/784; 707/E17.01

(57) ABSTRACT

A domain level database containing domain user permission settings may contain local device permission settings for domain users. For each of the local devices attached to the domain, a client service may periodically query the domain database and receive local permission settings for individual domain users. The local permission settings may affect access and availability of certain local resources and actions to the domain users. The client service may update a locally maintained database that may be used by a local security management system to permit or deny access to local resources and local actions to individual users when those users are logged onto the local device.

### BACKGROUND

Permission settings for computers and other devices attached to a network may be difficult to manage. In a network domain, two different types of privileges may exist. Domain privileges may be assigned to users on the domain and may permit access to domain level resources, such as servers, file systems, or applications that are available on the domain. Local privileges may be assigned to each user for each device attached to the network. A domain level privilege may define a user's privileges no matter what device the user uses to access the domain, but the same user may have widely different privileges from device to device.

For example, a network administrator may have administrative privileges across a domain, and may be able to set other user's access to resources on the domain, as well as create and modify those resources. A normal user on the domain may be able to access a specific subset of resources on the domain, but may not be able to perform the other functions that the network administrator may perform.

However, the normal user may have administrator privileges at the local level on the user's desktop computer, for example, but the network administrator may have only normal user privileges on the user's desktop computer. With the local administrator privileges, the user may add and remove software applications and perform other day to day administration of the local device.

Management of the local permission settings is typically performed at the local level and is performed at the device itself. A user with local administrative privileges may perform the duties of setting another local user's privileges. In a typical office or enterprise situation, each employee may have a single computer on which they have local administrative privileges. In order to configure local device access for different employees, each local administrator may have to set those permissions properly. When those permissions change, such as when an employee is hired or fired, many different devices may be updated and changed.

### SUMMARY

A domain level database containing domain user permission settings may contain local device permission settings for domain users. For local devices attached to the domain, a client service may periodically query the domain database and receive local permission settings for individual domain users. The local permission settings may affect access and availability of certain local resources and actions to the domain users. The client service may update a locally maintained database that may be used by a local security management system to permit or deny access to local resources and local actions to individual users when those users are logged onto the local device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with local permissions for domain users.

FIG. 2 is a diagram illustration of an embodiment showing a possible architecture of a domain database.

FIG. 3 is a timeline illustration of an embodiment showing a method for performing a user login sequence.

FIG. 4 is a timeline illustration of an embodiment showing a method for performing an update to a local security management database.

### DETAILED DESCRIPTION

A domain database may store local user permissions for various client devices. Each device may have a service that may update a local database from which local permissions may be loaded when a user logs onto a device. The local user permissions may be managed from a domain server and may be propagated to client devices across a network.

The domain database may contain individual entries for each device. In the entries, local user permissions may be set for individual users. Different devices may have different permission settings for the same user. For example, a user may be assigned administrator privileges on one device but guest access on a second device.

The local user permissions may not be related to domain user permissions. For example, a first user may have read-only access to a limited number of network resources, but may have full administrator access to the local device assigned to the user. A network system administrator may have administrative privileges for network services, but may have only guest access to first user's device.

The local devices may have a security management system that may permit or deny logon access and may set permissions for a user for the local resources. The local security management system may have a security management database in which is stored the permission settings for different users. A security management updater may periodically request updates from a domain controller, and many update the security management database with the updates.

Throughout this specification and claims, references may be made to local permissions and domain permissions. “Local” refers to a specific device, which is a client device of a domain. A local service is a service that operates on the local device. A user has local permissions that allow access to the local service. “Domain” refers to things that relate to the domain or network as a whole. A user that has domain privileges may be able to access services available to the domain, regardless of the client device the user is using. Domain privileges may be agnostic of the client devices, and client privileges may be agnostic of the domain services.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

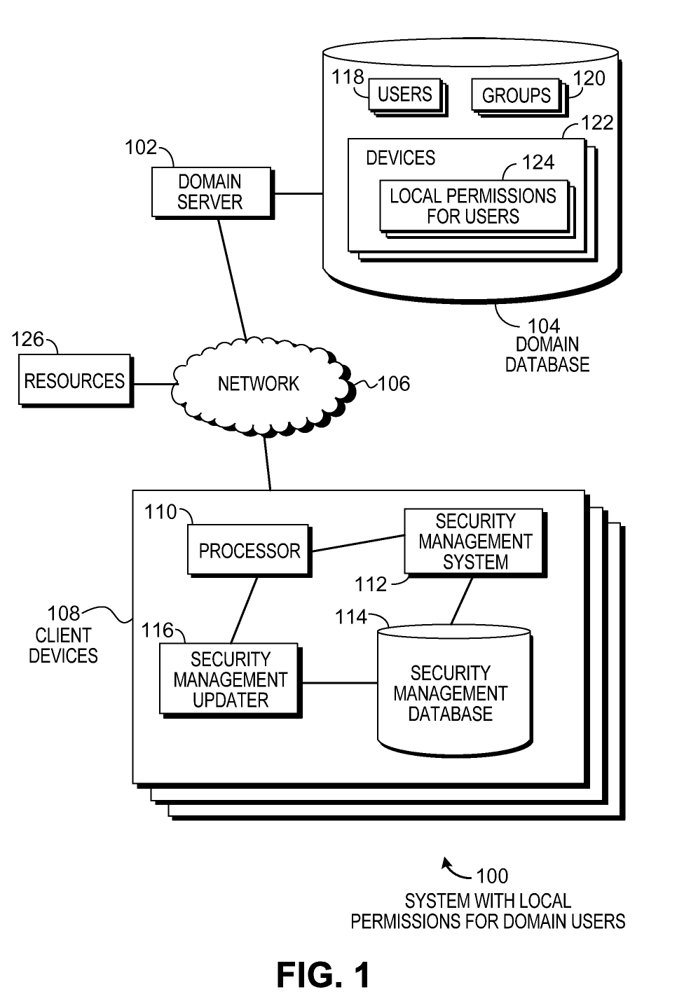

FIG. 1 is a diagram of an embodiment 100 showing a system with local permissions for domain users. Embodiment 100 is a simplified example of a system by which local accounts on client devices may be managed using a domain database.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a network of devices where the local permissions for individual users may be managed and controlled from a centralized source. Local permissions are user specific settings that may allow or disallow certain functionality and access to specific users on a local device. Each user may have a different set of settings on a local device.

A domain server 102 may have a domain database 104 that contains metadata about users, client devices, and the various permissions available for users across the network. The domain server 102 may be connected through a network 106 to many client devices 108.

The domain server 102 and client devices 108 may represent a local area network, although other network architectures may also be used. In a local area network, the client devices 108 may access various resources 126 across the network 106.

The resources 128 available across the network may be any type of shared resource. Examples of the resources 128 may be servers, file systems, storage devices, printers, scanners, and client devices 108 that are shared as resources. Other examples may include resources such as services, applications, and other software constructs or hardware devices that may be made available over a network.

In a typical embodiment, a domain server 102 may manage access for tens, hundreds, or even thousands of client devices 108. In large deployments, a system of multiple domain servers may be deployed across an enterprise, with various protocols being used to replicate the domain database 104 or portions of the domain database 104 across the various domain servers.

The domain server 102 may be a Lightweight Directory Access Protocol (LDAP) server. LDAP is a protocol by which client devices may send an operation request to a server and receive a response from the server. The LDAP server may maintain a domain database 104 that may contain information about users and devices on the network 106. Typically, an LDAP server may maintain user permission settings and other attributes about the users, and those settings may be arranged in a directory structure. An LDAP server may build, modify, and search the directory structure using the commands from a client device or from an application running on the domain server 102.

LDAP is one mechanism by which a network may be managed through a server. Other embodiments may use X.500, Directory Access Protocol, Domain Name System, and other directory services. Many embodiments may be based on LDAP technologies and may be extensions to a standardized implementation of LDAP.

An example configuration of a domain database is illustrated in embodiment 200 presented later in this specification.

The client devices 108 may have a processor 110 on which may be running a security management system 112. The security management system 112 may permit or deny certain operations, functions, or resources to individual users, based on entries stored in a security management database 114.

The security management system 112 may be an operating system level service that may allow a user to logon to the client device 108 and may set the user's permissions at the login operation. In some embodiments, the security management system 112 may deny a user access to the client device 108 if the user does not present credentials that match an entry in the security management database 114.

In some embodiments, the security management database 114 may contain passwords, encryption keys, or other credentials for each user of the client device 108. Such credentials may be stored using hashes or other technology so that the credentials may not be easily accessed. During a login attempt by a user, the user's password or other credential may be hashed and compared to the stored value in the security management database 114. Based on a successful match, the user may be allowed to continue a login process and may have certain local resources and local capabilities set for the user's session.

In some embodiments, a security management system 112 may perform a query to the domain server 102 during the login process to retrieve information about the user credentials. In some embodiments, the comparison between the user's credentials and stored credentials may be performed by a domain server 102, while in other embodiments, such comparisons may be performed by the security management system 112 on the client device 108.

During a login process, a user may be granted a set of domain permissions and a set of local permissions. The domain permissions may allow or deny access to resources available over the network 106, and the local permissions may allow or deny access to local resources available on the client device 108.

Some client devices 108 may have two different login mechanisms for local users and domain users. For example, a local user may be limited to those users who have a local entry in the security management database 114. In many cases, a local user may be permitted access to local resources, but may be denied access to domain resources.

Continuing with the example, a domain user may attempt a login to a client device 108 using domain credentials. In such a case, the security management system 112 may attempt to find the user's credentials from the local security management database 114 and, if the credentials are not found, may query the domain server 102 to determine if the user's credentials may be found in the domain database 104. If the domain database 104 contains the user's credentials, the credentials may be transmitted to the client device 108 and the user may be permitted to logon to the client device 108.

Both local and domain permissions may be defined in access control lists for users and devices. An access control list may contain a list of permissions attached to an object and may specify who or what is allowed access to the object and what operations are allowed to be performed on the objects. Embodiments that use access control lists can be classified into discretionary and mandatory. A discretionary access control system typically allows the owner of an object to fully control access to the object, including altering the access control list to grant access to other objects. A mandatory access control list may enforce system-wide restrictions that override permissions in an access control list.

In some embodiments, an access control list may be a table or other data structure that may contain entries that specify individual user or group rights to specific system objects, such as a program, process, or a file. Some embodiments may use a term of access control entries for such access control lists. The privileges or permissions may determine specific access rights, such as whether a user can read from, write to, or execute an object. Some embodiments may control whether a user or group of users may alter an access control list of an object.

Some embodiments may use a role based access control mechanism. In some embodiments, role based access control may be referred to as role based security. In role based access control, roles may be created for various functions, such as a job function within a company or other enterprise. The permissions to perform certain operations may be assigned to specific roles. Users may be assigned one or more roles, and through the role assignments, the user may receive permissions to perform certain functions or access certain resources.

In a role based access control mechanism, groups may be defined that align with the roles within the role based access control. Examples of various groups or roles may be described in embodiment 200 later in this specification.

A set of local permissions may permit or deny access to local resources. Examples of local resources include local file directories, local peripherals such as printers and scanners, and various services that may operate on the client device. For example a user may be permitted the following types of access to a file system: full control, traverse folder, execute file, list folder, read data, read attributes, read extended attributes, create files, write data, create folders, append data to folders, write attributes, change permissions, take ownership, and other permissions. In another example, a user may be permitted access to a printer for printing, modifying the printer setup, using specific functions of the printer such as color printing, and allowing or disallowing access to the printer for other users or services. Many other examples may exist based on the client device 108 and the capabilities of the client device 108.

In the domain database 104, there may be definitions for users 118, groups 120, and devices 122. User definitions may have user specific attributes, such as login name, passwords, and other credentials. Groups 120 may define the roles described above and may operate as a template for permissions that may be applied to members of the group. In a simple example, a member of a general user group may have access for using a resource, but may not have access for modifying the resource that a member of an administrator group may have.

The domain database 104 may have local permissions for users 124 for each device 122. The local permissions for users 124 may be separate sets of permissions for individual users for each device. In many embodiments, the sets of permissions may be defined by assigning a user to a group or role for each device. For example, a user may be assigned to an administrator group, which may allow the user full access to install software, modify services, and configure the client device. Another user may be assigned to a general user group and may be able to use the services available on the device, but may not be able to install software, modify services, or perform other configuration operations.

A security management updater 116 may be a service that operates on the client devices 108 and may periodically update the local security management database 114 with the local permissions for users 124 from the domain database 104. In a typical embodiment, the security management updater 116 may send a query to the domain database 104 and may download and store changes in the local security management database 114.

The combination of the local permissions for users 124 in the domain database 104 and the security management updater 116 may allow remote management of local user permissions. An update may be made to the local permissions for users 124 and the update may be propagated to the client device 108 by the periodic query mechanism of the security management updater 116.

In many embodiments, the security management updater 116 may perform an update while one user is logged into the device. When the security management updater 116 performs an update, the permission settings for the currently logged in user as well as many other users may be updated.

In one use scenario, a user may have a personal computer assigned in a workplace. The user may be a local administrator of the personal computer and may perform many of the day to day administration activities on the personal computer, such as installing and updating software applications. In some computer systems, the original user of a computer system may be an administrator of the system but no other users may be. While the user is away on vacation, or when the user transfers to another department, a computer technician may be assigned administrator privileges to the personal computer so that the computer technician may update the computer or to access some data. By changing the local permissions for users 124 in the domain database 104, the computer technician's privileges may be set in the local security management database 114.

In another use scenario, a user within a company may be assigned a device and may perform an initial configuration. The user may log into the domain through the domain server 102 and a record for the device may be created in the domain database 104. Once the record for the device 122 is established, a network administrator may assign certain users to groups associated with the local permissions for users. For example, the user's supervisor may be assigned local administrator privileges along with the user's department computer service technician. The local permissions for users may be set by modifying the domain database 104 without having to logon to the client device 108 and modify the permission settings locally.

In some embodiments, the security management updater 116 may receive periodic transmissions from the domain server 102 and may update the security management database 114 using the information received from the domain server 102. In such an embodiment, updates or changes to the local permissions for users 124 may be pushed to the client devices 108. In an embodiment where the security management updater 116 requests data from the domain server 102, the client devices 108 may pull data from the domain server 102.

The client devices 108 may be any type of device that may connect to a domain server 102 and through which a user may logon. In many embodiments, the client devices 108 may be personal computers where a user may login using a user account name and password. In some embodiments, the devices may be a portable data collection and display device, such as a hand held scanner and the user may login using a smartcard or other hardware technology.

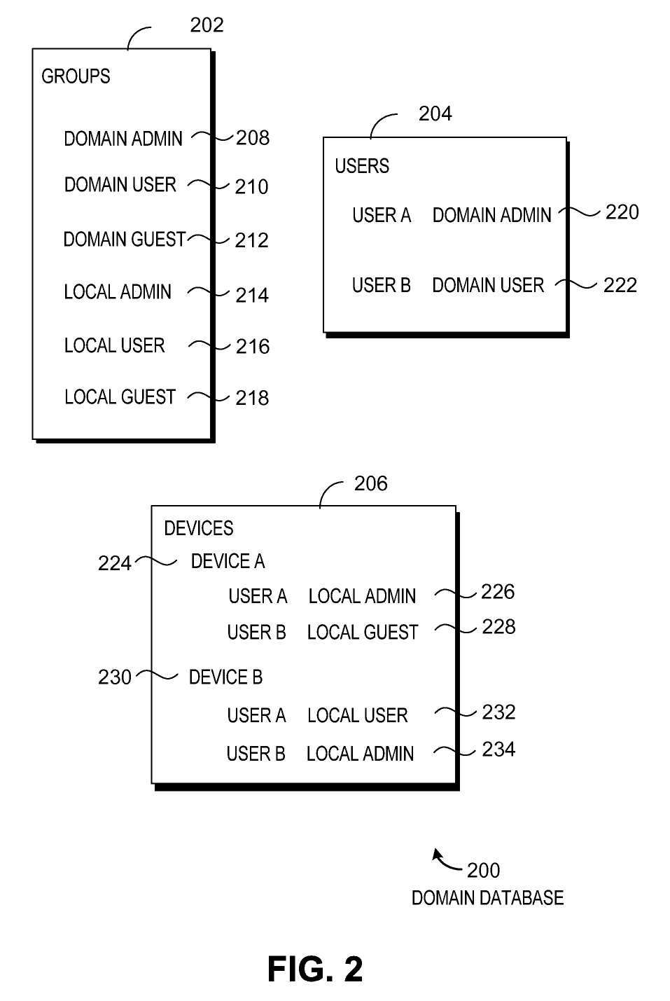

FIG. 2 is a diagram of an embodiment 200 showing a domain database. Embodiment 200 is a simplified illustration of a subset of data that may be in a domain database, such as the domain database 104. Embodiment 200 is merely one example of how a domain database 104 may be configured using groups to define permissions for users, and then assigning users to groups for various client devices.

The domain database of embodiment 200 may have separate entries for groups 202, users 204, and devices 206.

The groups 202 may define different roles a user may be assigned, and each role may have a specific set of permissions or settings associated with the role. In many embodiments, a group may have many several to hundreds of individual settings.

Entries within the groups 202 may be defined for domain and local roles. For example, domain level roles may be a domain admin 208, domain user 210, or a domain guest 212. Local level roles may be a local admin 214, local user 216, and local guest 218.

In the example of embodiment 200, an admin group may define privileges and permissions that allow the user to perform configuration and management operations. A domain admin may be able to perform such configuration operations for domain services, while a local admin may be able to perform configuration operations for local services on a specific device.

Similarly, a user group may define privileges and permissions that allow a user to access and perform some manipulation of services. Typically, a user group may not permit a member to perform configuration operations. A domain user may be able to access and use domain services, and a local user may be able to access and use local services on a client device. In some embodiments, user accounts may be able to access and manipulate data within a database, from which other accounts, including admin accounts may be restricted.

In many embodiments, different types of domain user accounts may be defined for different types of users. For example, a finance department may define a user account for accountants that may enable the accountants to have access to certain features of a financial database, while a bookkeeper user account may be defined that allows a more limited access to the features of the financial database. Within the same company, a shipping department user group may be defined that does not allow any access to the financial database.

In the definitions for users 204, each user may be assigned to one or more groups for domain access. For example, User A may be assigned as a member of the domain admin group in entry 220 and User B may be assigned as a member of the domain user group in entry 222.

The entries in the definitions of users 204 may include many other parameters for the users. For example, the user's full name, email address, telephone number, and other information may be stored along with the user's credentials such as user name and password.

In many embodiments, a user may be a member of several groups. For example, a user may be assigned to both domain admin and domain user groups. In other embodiments, a user may be a member of several dozen or hundreds of groups.

For the definitions of devices 206, each device may have a separate entry in which a user and a group membership may be defined. For example, Device A has entry 224, under which User A is assigned as a member of local admin group in entry 226 and User B is assigned as a member of local guest group in entry 228. Similarly, Device B has entry 230, under which User A is assigned as a member of local user group in entry 232 and User B is assigned as a member of local admin group in entry 234.

In many embodiments, the definitions of devices 206 may include many different entries for each device. For example, the entries 224 and 230 may include information about each device, from the device type and operational characteristics, to the domain services that may be available to the device.

The entries for the devices 206 illustrate each user as being a member of a group that may be defined within the domain database. In this manner, a group may be defined at the domain level that contains settings that may be applied at a local level on specific devices.

In many such embodiments, the specific settings or permissions available may be different from one type of device to another. For example, a personal computer with one operating system may have a different set of permission settings than a handheld scanning device that uses a different operating system. In such an embodiment, different groups may be defined for specific types of devices, different operating systems, or for other peculiarities.

In some embodiments, the local settings for a user may be defined by individual permissions in addition to or in lieu of settings that are defined in a group. For example, in the entry 226, User A may be a member of a local admin group but may also have read only access to a data directory for an application that operates on Device A. The read only access to the data directory may be a single permission setting defined within the entry 226.

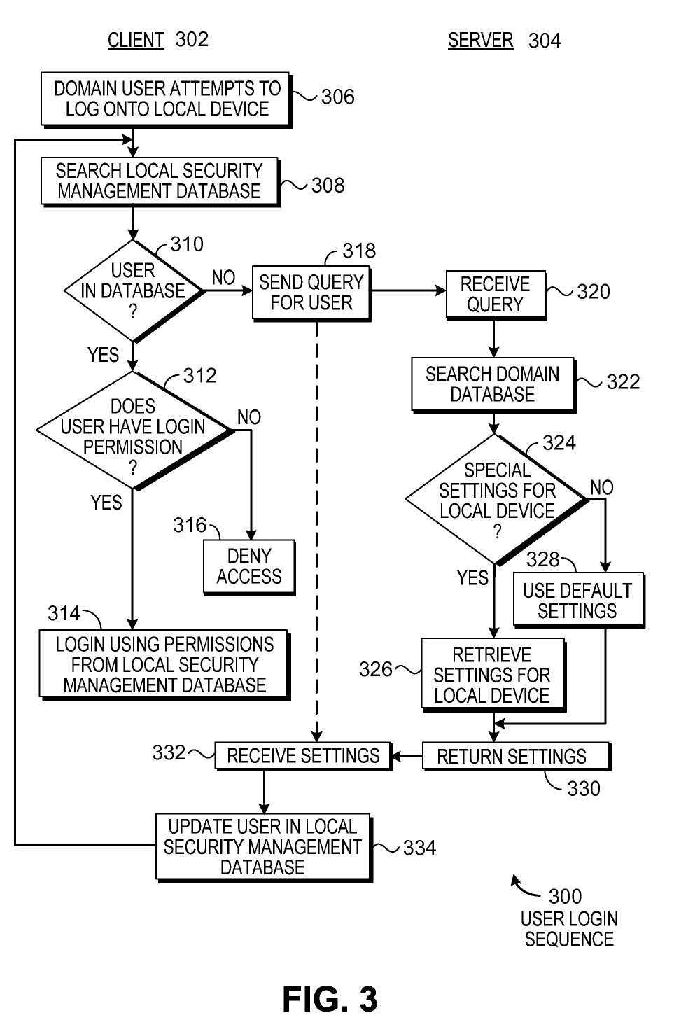

FIG. 3 is a timeline illustration of an embodiment 300 showing a sequence for a user login operation. Embodiment 300 is a simplified example of merely one method that may be performed by a client 302 and a server 304. The client 302 may correspond to the actions of one of the client devices 108 and the server 304 may correspond to the actions of the domain server 102 described in embodiment 100. The actions of a local device or client 302 are illustrated on the left hand side of the figure, and the actions of a domain server 304 are illustrated on the right hand side of the figure.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is one example of sequences and handshaking that may be performed by a client 302 and server 304 during a login sequence. Embodiment 300 illustrates a method by which a user may attempt a logon to the client 302. If the user's credentials are not in a local security management database, the credentials are retrieved from the server 304 and stored in the local security management database. The login is then completed using data from the local security management database.

In block 306, a domain user may attempt to logon to the local device, which is the client 302. When a domain user logs onto a local device, the domain user may receive two sets of permissions: a set of permissions for domain services and a set of permissions for local services.

A search of the local security management database may be made in block 308. If the user is in the local security management database in block 310, and the user has login permission, the user may be permitted to login using permissions from the local security management database in block 314. When the user is logged on in block 314, the local user permissions and domain user permissions may be applied to the session, and both sets of user permissions may be retrieved from the local security management database.

In block 314, a local security management system may perform additional operations, such as confirming the user's credentials with credentials in the local security management database.

If the user does not have login permission in block 312, the user's access is denied in block 316.

If the user is not in the local security management database in block 310, a query for the user may be sent in block 318 from the client 302.

The server 304 may receive the query in block 320 and search the domain database in block 322 for a record of local settings for the user on the client 302. If special settings for the user on the local device are found in block 324, the settings may be retrieved in block 326. If no special settings are found for the user on the local device in block 324, default settings may be used in block 328.

In many embodiments, a rule, database entry, or other mechanism may be used to define default settings for the local permissions for a user in block 328. In some embodiments, the user's domain settings may affect the default local settings. For example, a domain administrator may be given local administrator privilege as a default setting, and a domain user may be given local user privileges as a default setting. Other embodiments may assign all users guest privileges unless otherwise specified, for example.

Once the settings are determined in blocks 326 or 328, the settings may be returned by the server 304 in block 330.

The settings may be received in block 332 and the user's entry in the local security management database may be created and updated in block 334. The client process may return to block 308.

Embodiment 300 is just one example of an implementation of local security settings on a per user basis for individual devices. Embodiment 300 illustrates a method whereby each user of the client 302 has an entry in a local security management database. In some embodiments, the client 302 may query the server 304 for information relating to a domain user and may use the response from the server 304 without adding the information to the local security management database. In such a case, the embodiment may receive settings in block 332 and the process may proceed directly to block 312.

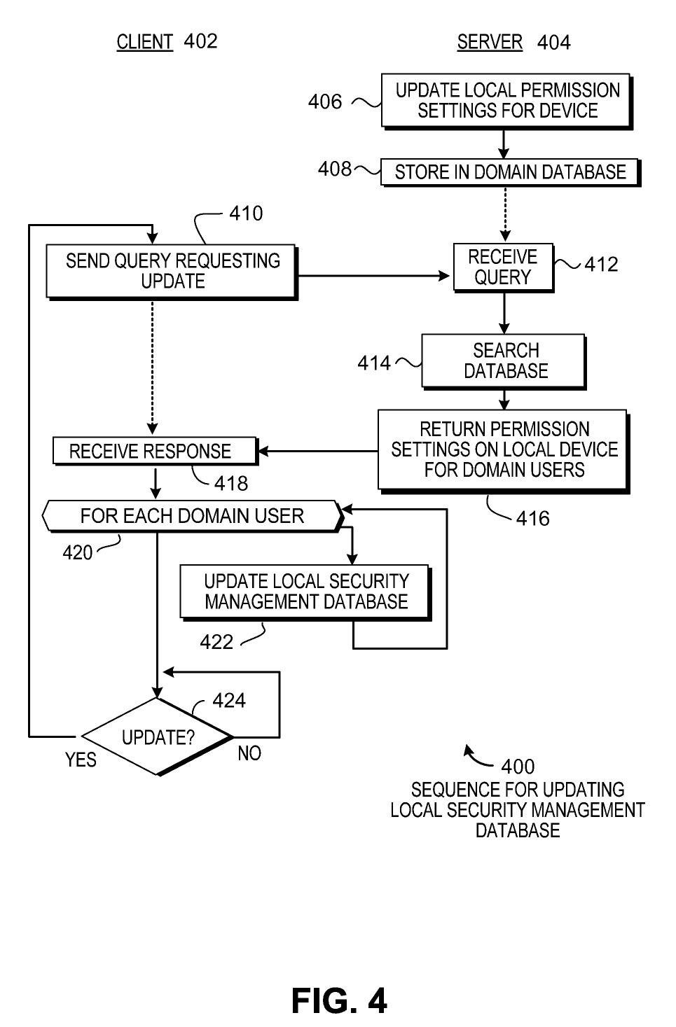

FIG. 4 is a timeline illustration of an embodiment 400 showing a sequence for updating a local security management database. Embodiment 400 is a simplified example of merely one method that may be performed by a client 402 and a server 404. The client 402 may correspond to the actions of one of the client devices 108 and the server 404 may correspond to the actions of the domain server 102 described in embodiment 100. The actions of a local device or client 402 are illustrated on the left hand side of the figure, and the actions of a domain server 404 are illustrated on the right hand side of the figure.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one method by which a local security management database may be updated. The operations of the client 402 may represent the operations of a security management updater 116 as illustrated in embodiment 100.

In block 406, an update is created to a local permission setting for a specific user on a specific device and in block 408, the update is stored in a domain database. In some cases, an update to the database may cause a new record to be created or a new entry within a record to be created. Because each embodiment may have different types of databases, each having a different configuration, the precise method for managing the database may vary from embodiment to embodiment.

In many cases, some type of user interface may be used to make the changes in block 406. Many servers may have a local console or remote access console through which an administrator may monitor and update many different parameters about the server. In such a case, the server may have a graphical user interface, scripting interface, command line interface, or some other mechanism by which an administrator may select the desired settings and cause the settings to be entered into the database in block 408. In many such embodiments, the process of creating and storing updates may be partially or fully automated using scripting or other executable languages.

In block 410, the client 402 may send a query requesting updates.

In block 412, the server 404 may receive the query and may search a domain database in block 414. In block 416, the permission settings for the local device for domain users may be returned as a response.

The response may be received in block 418 by the client 402.

For each domain user in the response in block 420, the local security management database may be updated in block 422. In many cases, an update may cause a new entry to the local security management database, or the update may cause an entry to be removed.

If it is time for another update in block 424, the process may return to block 410. Otherwise, the process may hold at block 424.

Embodiment 400 is an example of a pull-type system where the client 402 requests updates from the server 404. Other embodiments may be a push-type system where the server 404 may transmit updates to the client 402 when the updates occur.

In a pull-type system as illustrated, the client 402 may periodically request an update. In some such embodiments, a predefined frequency of updates may be used. In order to minimize network congestion, some embodiments may have a predefined or random jitter applied to a predefined frequency. When jitter is included in the update frequency, the updates may occur at approximately the predefined interval, plus or minus the amount of jitter. Such systems may be useful when a large number of devices may be requesting updates over a single network and may be helpful in spreading out queries so as not to overload the server 404 or cause high bandwidth usage.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a domain server having a domain database, said domain database comprising:
user metadata for a plurality of domain users, said user metadata comprising domain level permissions for each of said domain users;
device metadata for a plurality of local devices, said device metadata comprising local permission settings for said domain users;
a plurality of local devices, each of said local devices comprising:
a local security management database comprising permission settings for local users on said local device;
a local security management system configured to permit or deny access to local resources based on said permission settings in said local security management database; and
a security management updater configured to receive a set of local permission settings for said domain users for said local device, and update said local security management database with said local permission settings for each of said domain users for said local device.

2. The system of claim 1, said domain database being an LDAP database.

3. The system of claim 1, said local security management system being further configured to permit or deny access to said local device based on said permission settings.

4. The system of claim 1, said local permission settings being defined for one of said domain users by assigning said domain user as a member of a group.

5. The system of claim 4, said domain database having a plurality of local permission groups, each of said local permission groups having a set of permissions.

6. The system of claim 5, one of said local permission groups being an administrator group.

7. The system of claim 4, said domain user being assigned to a plurality of groups.

8. The system of claim 1, said domain users for said local device being a subset of said domain users as defined in said domain database.

9. The system of claim 1, said security management updater being configured to query said domain database.

10. The system of claim 9, said security management updater being configured to query said domain database on a periodic basis.

11. The system of claim 9, said security management updater being configured to query said domain database while one of said domain users is logged onto said local device.

12. The system of claim 1, said security management updater further configured to receive said local permission settings for a subset of said domain users having non-default permissions, and said local security management system further configured to use a set of default permissions for those domain users not in said subset.

13. A method performed on a local device, said method comprising:
on a predetermined frequency, performing a query to a domain database, said domain database comprising:
user metadata for a plurality of domain users, said user metadata comprising domain level permissions for each of a first plurality of domain users;
device metadata for said local device, said device metadata comprising local permission settings for a second plurality of said domain users;
receiving a set of local permission settings for each of said second plurality of said domain users;
for each of said second plurality of said domain users, storing said set of local permission settings in a local security database; and
permitting one of said second plurality of said domain users access to local device resources according to said local permission settings.

14. The method of claim 13, said second plurality being equal to said first plurality.

15. The method of claim 13, said local device resources comprising local administrator privileges.

16. The method of claim 13, said permitting being performed when said one of said second plurality of domain users logs onto said local device.

17. The method of claim 13, said local permission settings further comprising passwords for said second plurality of domain users.

18. A method comprising:
updating a database, said database comprising:
user metadata for a plurality of domain users, said user metadata comprising domain level permissions for each of a first plurality of domain users;
device metadata for a first plurality of local devices, said device metadata comprising local permission settings for said domain users; and
said updating comprising changing said local permission settings for a subset of said domain users for a second plurality of said local devices; and
for each of said second plurality of local devices, receiving a query and responding to said query with said local permission settings for said domain users, said local permission settings being used by said local devices to update a local permission database and to change access permissions to local resources for said domain users on said local device.

19. The method of claim 18, said database being an LDAP database, said device metadata comprising an extension to said LDAP database.

20. The method of claim 18, said subset of domain users having administrator privileges on said local devices.
